(19) United States
(12) Patent Application Publication
(10) Pub. No.: US 2011/0084133 A1
(43) Pub. Date: Apr. 14, 2011

(54) METHOD, SYSTEM AND APPARATUS FOR IDENTIFICATION

(76) Inventor: Kip Sawdy, Jackson, WY (US)

(21) Appl. No.: 12/576,690

(22) Filed: Oct. 9, 2009

(51) Int. Cl. G06K 5/00

(52) U.S. Cl. 235/380

(57) ABSTRACT

Method, system and apparatus for providing data. The method, system and apparatus can include at least one database for storing data. Further, the method, system and apparatus may utilize a plurality of cards containing individualized information about the holders of the cards and a data storage device may be coupled with each of the plurality of cards. The data storage device can be readable by a data reading device and can store further individualized information about the holders of the cards. Additionally, the at least one database can store the individualized information from the plurality of cards. Also, a plurality of authorized personnel may be equipped with data reading devices to read the data on the data storage device.

### BACKGROUND

Identification systems are widely utilized in various nations and jurisdictions around the world. Typical identification systems revolve around a government issued identification card and the assignment of an identifier, such as a social security number. Examples of identification systems include driver's licenses and the information found thereon, social security cards and the related numbers and voter registration cards. Additionally, Homeland Security Presidential Directive 12 (HSPD-12) was enacted by President Bush to require extensive background checks and the submission of detailed information in order to acquire various government identification cards (such as “smart cards”) which may be used to access various government facilities and/or computers.

These identification systems, however, do not typically provide information beyond the carrier's name, address or physical characteristics, provided they have fulfilled any requirements to be admitted into such an identification system. Thus, in many situations, although the name of the person may become known by another party who is checking the identification of the person, important relevant information about the person may not be known. In some situations, such as where a person has been in an accident or is experiencing a medical emergency, they may be incapacitated or otherwise unable to provide any information to an emergency responder. Thus, in these situations, an emergency responder may not have access to important medical, physical or other information that could be of assistance or beneficial for the emergency responder to know.

### SUMMARY

One exemplary embodiment can describe a system for providing data. The system for providing data can include at least one database for storing data. The system may also include at least one database for storing data. Also, the system can include a plurality of cards containing individualized information about the holders of the cards and a data storage device coupled with each of the plurality of cards, where the data storage device can be readable by a data reading device and can store further individualized information about the holders of the cards. Further, the at least one database can store the individualized information from the plurality of cards and a plurality of authorized personnel may be equipped with data reading devices that can read the data on the data storage device.

Another exemplary embodiment can describe a method of maintaining and disseminating data. The method can include steps for gathering data regarding a plurality of individuals; storing the data in one or more centrally located databases; storing individualized data regarding each of the plurality of individuals on a plurality of identification cards; reading the data on the plurality of identification cards by a data reading device; and displaying the data.

### BRIEF DESCRIPTION OF THE FIGURES

Advantages of embodiments of the present invention will be apparent from the following detailed description of the exemplary embodiments thereof, which description should be considered in conjunction with the accompanying drawings in which:

FIG. 1 is an exemplary diagram showing an identification card.

FIG. 2 is an exemplary diagram showing a data and identification system.

FIG. 3 is an exemplary flowchart showing steps for collecting and disseminating data.

FIG. 4 is an exemplary diagram showing an identification system.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

The word “exemplary” is used herein to mean “serving as an example, instance, or illustration.” Any embodiment described herein as “exemplary” is not necessarily to be construed as preferred or advantageous over other embodiments. Likewise, the term “embodiments of the invention” does not require that all embodiments of the invention include the discussed feature, advantage or mode of operation.

Further, many of the embodiments described herein are described in terms of sequences of actions to be performed by, for example, elements of a computing device. It should be recognized by those skilled in the art that the various sequence of actions described herein can be performed by specific circuits (e.g., application specific integrated circuits (ASICs)) and/or by program instructions executed by at least one processor. Additionally, the sequence of actions described herein can be embodied entirely within any form of computer-readable storage medium such that execution of the sequence of actions enables the processor to perform the functionality described herein. Thus, the various aspects of the present invention may be embodied in a number of different forms, all of which have been contemplated to be within the scope of the claimed subject matter. In addition, for each of the embodiments described herein, the corresponding form of any such embodiments may be described herein as, for example, “a computer configured to” perform the described action.

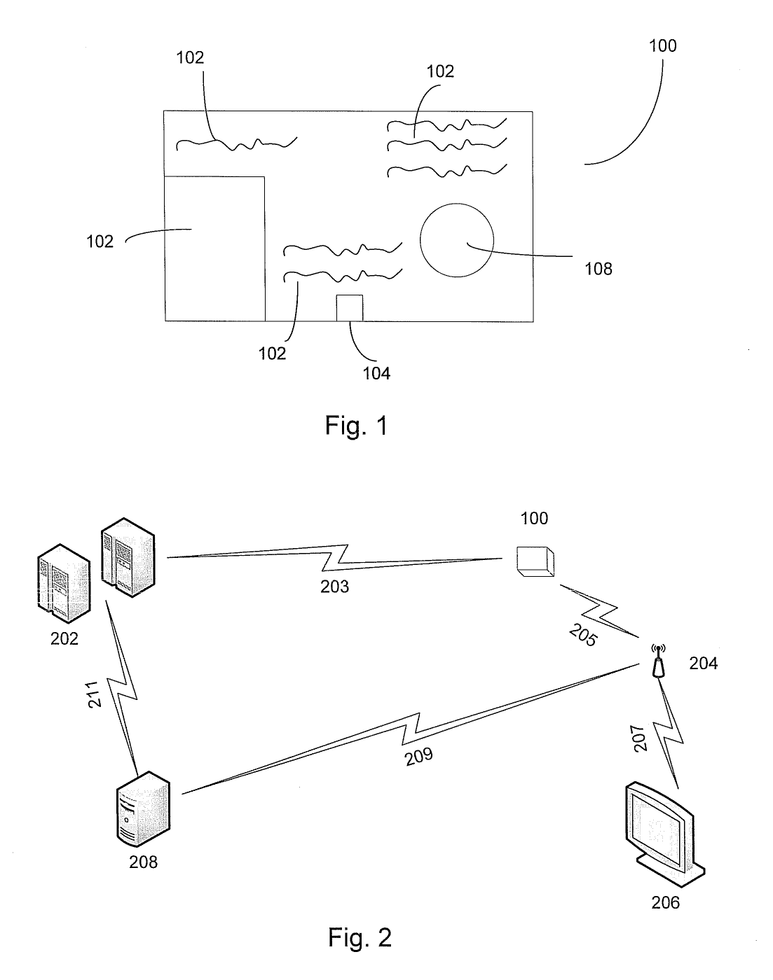

Generally referring to exemplary FIGS. 1-2, methods, systems and apparatuses for providing data may be described. The methods, systems and apparatuses can include one or more cards on which data regarding individuals may be stored as well as one or more remotely located databases on which data regarding a number of individuals can be stored. Further, in some exemplary embodiments, there may be a variety of ways in which data is collected and stored on the cards.

In one exemplary embodiment, an identification card may be utilized. The identification card 100 may be formed in any of a variety of manners, for example a card printed on plastic, paper that may be laminated or any other manner known in the art. The card 100 may include any of a variety of information, for example physical information about a user of the card, address information, identification information and medical information, as well as any other desired information, any of which may be printed on the card, for example in area 102. Additionally, information contained on the card can include medical conditions or any other information that might be relevant to a person or professional interacting with the user of the identification card, such as a police officer or emergency medical technician. Further, the card 100 can include any other desired data, rights or privileges that may be afforded to the holder. Examples of other data, rights or privileges include driver's license information, passport information, firearm permit information or any other desired data or information. Any indicia which may be printed on the card 100 may be printed in any area and may not be limited to area 102 as shown in exemplary FIG. 1.

The card 100 may also have one or more electronic devices or storage medium embedded into it, attached thereto or otherwise coupled or associated with it, such as electronic device 104. Alternatively, the card 100 may have one or more electronically readable media printed thereon, attached thereto or coupled or associated with it, such as a barcode, which may be printed in any desired location. Examples of the electronic devices 104 that may be associated with the card 100 include a radio frequency identification (RFID) tag, a computer chip or a memory device. The electronic device 104 or electronically readable media may include any desired information. Examples of such information can include medical history, current medical conditions, identification information, physical information, family contact information or any other information that may be desired to put on the card 100 or which may be useful to a police officer, emergency medical technician, search and rescue team or any other party providing care or service to the user of the card 100. Additionally, any other desired information, such as vehicle registration, vehicle insurance, health insurance, firearms permit information or any other data may further be included on the electronic device 104 or electronically readable media. In still further exemplary embodiments, a person's legal or citizenship information may also be included on the electronic device 104 or electronically readable media. Examples of this can include passport information, visa information, green card information, resident alien information or any other form of legal or citizenship data. Also, in some further examples, identification information beyond a person's name and social security number, and the like, may be included. Here, other identifying information, such as fingerprint information, dental record information and any other identifying information may be included on the card 100.

In still further exemplary embodiments, other indicia may be printed or disposed on the card 100. For example a picture 106 may be printed or otherwise disposed on the card 100 at any location. Similarly, a seal 108, such as a state or national seal, or a seal of any other jurisdiction, may further be printed or disposed on the card 100. Additionally, and as discussed herein, any other desired information may be disposed on the card 100 as desired.

In another exemplary embodiment, information on the card 100 may be scanned or otherwise read by any of a variety of authorized parties. Examples of authorized parties can include police officers, emergency medical technicians, doctors, coroners or any other party who may provide service, care or treatment to a user of the card 100. The card 100 may be read or scanned in any of a variety of manners, depending upon the storage medium or electronic device associated with the card or the electronically readable media. In some exemplary embodiments, a wireless, handheld scanner may be used to scan the card and/or any data found within the card 100. For example, if an RFID tag is associated with the card 100, the tag may be read with an RFID reader. Similarly, if a barcode is associated with the card 100, a barcode reader may be used to garner the information on the card 100. Any information that is received from the card 100 may then be transmitted back to a central location, such as a police station or a hospital, as desired or as may be beneficial in a situation.

Further, any time a card 100 may be scanned, a report may be generated or an alert otherwise formed. This may allow for the prevention of abuse of the identification system, method and apparatus as well as prevent identity theft. For example, in some situations, authorized personnel may sign a form or otherwise show their identity and reasons for using a scanning device prior to being able to perform a scan. In other examples, a scanner may not be active until the reason for the scan is deemed appropriate or desired by an appropriate party. Additionally, if a scanner is used on a card 100, the cardholder may be provided with a report of when the scan was performed or why the scan was performed. This report may be generated electronically when the scan is made and may be transmitted to the cardholder in any desired fashion, for example email, text message, phone call, mail, fax or any other known manner. The report may further include, or the cardholder may further be given access to any of a variety of information regarding the scanning of his or her card 100, including the party who performed the scan, the entity for whom the party who performed the scan is employed, contact information for questions regarding the scan and any other desired information. Alternatively, if a scan is made under certain conditions, for example after a card holder's death by a coroner, for example to determine an identity, notification may be sent to the card holder's family members or next of kin.

In yet a further exemplary embodiment, one or more databases may be used to contain the information on the cards 100. In different examples, a different number of databases may be utilized or different data centers having different numbers of databases may be utilized. For example, each state may have one or more centrally located databases that may contain the data associated with the cards possessed by citizens of that state. Similarly, other exemplary embodiments can have centralized databases provided on a city, county or national level, or any other division of data storage as desired.

As shown in exemplary FIG. 2, any number of databases may communicate with one or more cards. In this example, databases 202 may store any desired information, as discussed previously. Databases 202 may communicate in any desired manner with a card 100, such as through a wired or wireless connection 203 to allow for any updating of a card 100 or to report any scanning of card 100. Card 100 may further be scanned at any time, for example using scanner 204 to wirelessly read any data on card 100 through connection 205. Scanner 204 may then have any desired type of display or may be capable of wired or wirelessly transmitting, for example through connected 207 any data collected from card 100 to a display 206. Further, after a scan is performed by scanner 204, a communication may be sent, for example through communication link 209 to a remote server 208 that can provide an indication to the cardholder of card 100 that the card 100 has been scanned, as discussed herein. Further, any data that may be sent or stored on remote server 208 may also be shared with databases 202, for example through communication link 211.

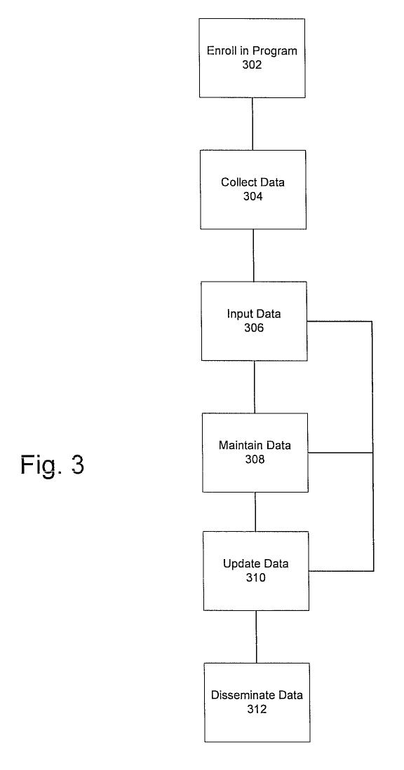

In still a further exemplary embodiment, and as shown in the exemplary flowchart in FIG. 3, a jurisdiction may have its residents, members or citizens enroll in a program 302 that provides information to be stored on an identification card or may have its residents, members or citizens submit information to a governing body or data administrator. In such exemplary embodiments there may be one or more agencies, administrations or other personnel that collect data from individuals 304, input data into one or more databases 306, maintain the data in the one or more databases 308, update the data in the one or more databases 310 and disseminate data from the one or more databases 312. As discussed previously, individuals may provide one or more types of data to a card administering body. The data may be submitted in any of a variety of manners, for example through an electronic data submission system (including an online interface) or through any other manner of providing or submitting data. Additionally, as discussed with respect to other examples, the information may be communicated back and forth amongst several sources, for example from a card to a scanner, from a scanner to a display, from a scanner to a server, from a server to a database and from a server to an enrolled member of the program.

The data submitted by the individuals in step 304 may be any of a variety of types of information. Examples of data submitted may include personal identification information, such as a full name, address, social security number and the like. Additionally, physical information such as height, weight, hair color and eye color may also be submitted. Other information can include medical information, such as ongoing medical conditions or medical needs, DNA information, blood type, medical history, legal or criminal history, next of kin information or any other desired information.

In another exemplary embodiment, a jurisdiction may incentivize citizens or members of the jurisdiction to carry the card on them or with them or to enroll in the program, as in step 302. For example, while an individual is in a jurisdiction, they may have the card on their person or with their belongings. Alternatively, if a person is not carrying a card on their body or with their person, he or she may be penalized. A person may be penalized in any desired manner, for example a warning, citation or fine.

In still other exemplary embodiments, the card may provide a source of revenue for an administering body. In this example, when an individual registers or otherwise provides information to an administering body, a fee may be charged by the administering body in conjunction with an enrollment in step 302. The fee may be any desired fee and may be used for any desired purpose. For example, the fee may be used to provide the card to the individuals. Additionally, the fee may be used to help maintain, update and backup the data. Further, the fee may be used to pay personnel associated with the administering body or may be disseminated or shared with any other entity or agency, including government entities and agencies. For example, the fee may be used to repay any form of debt (e.g. national debt), allocated to pay for other projects (e.g. national or state repair or relief projects) or used in any other desired manner. Additionally, any funds used or allocated as a result of the present method, system and apparatus may be made either publicly available or available to people or personnel who have or use the cards or the identification system. This information may be made available in any manner, for example through the publishing on a website.

In still further exemplary embodiments, upon fulfilling any other requirements or suggestions prior to receiving an identification card, a potential card holder or user may agree to any desired terms or conditions. Terms or conditions may include a waiver of the ability to sue a first responder, emergency medical technician or the like.

In other exemplary embodiments, the systems, methods and apparatuses described herein may be used on any scale. Thus, while an implementation may be utilized on a local scale, it may also be utilized on a national or international scale. For example, such systems, methods and apparatuses may be utilized throughout the United States. Similarly, these systems, methods and apparatuses could also be used in another country, such as China. The systems, methods and apparatuses may further be able to communicate across international borders, thus allowing for data scans, information updates or any other desired use of the methods, systems and apparatuses to occur anywhere where any relevant tools or equipment are available. Similarly, if a scan occurs in any nation, desired contacts or messages may be dispatched to any other desired nation or locality, as may be dictated by the conditions of the scan or the situation.

In a different exemplary embodiment, the embodiments described herein may be used in conjunction with another national identification system, such as the social security number system. Here, upon a scan of an identification card after a card holder has died, for example by a coroner, a notification may be sent that the card holder is dead and that the card holder's social security number is no longer active. This may assist, for example, in helping to prevent identity theft and some governmental fraud through the use of a deceased person's social security number. Additionally, in this exemplary embodiment, the social security administration may be immediately notified of a person's death and may take any further precautions desired. For example, they may choose to deactivate a social security number for a period of years before reissuing it to a new person.

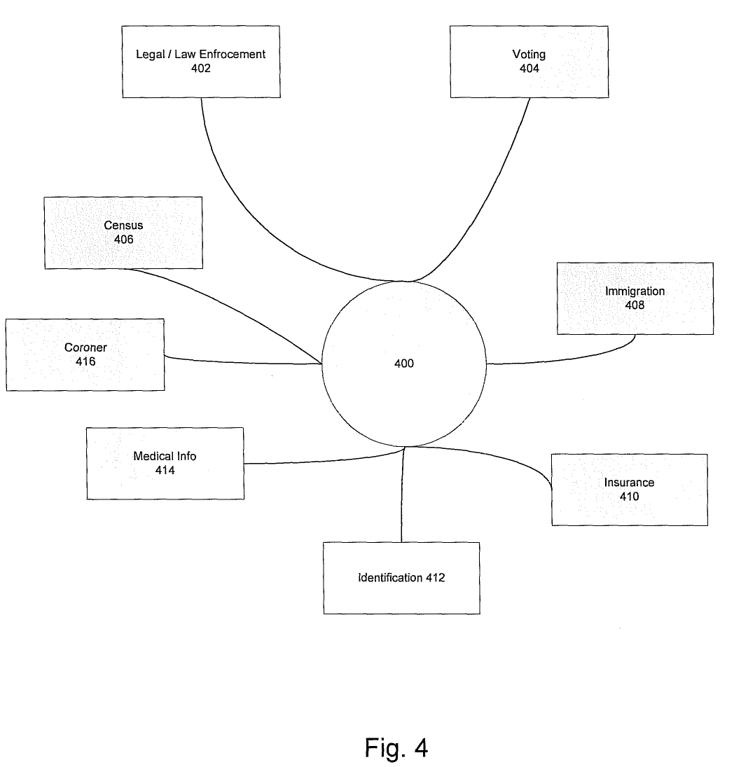

In another exemplary embodiment, and as shown in FIG. 4, an identification system and apparatus may be used to perform any of a variety of functions. Further, the functions shown in exemplary FIG. 4 may be performed simultaneously or in concert with one another. Additionally, any number of functions may be employed or utilized by with the system 400 and the number of functions employed by a system 400 in one embodiment may be different from the number of functions that may be employed or utilized in any other embodiment. Examples of uses include legal and law-related uses 402, which can include criminal history as well as contact information for the purposes of serving warrants, locating individuals and monitoring individuals. Additionally, the system 400 can be used for voting 404 or voter registration services, as well as identifying people at polling places. The system 400 may also be used for census 406 information so as to provide accurate and up-to-date information about a populous. The system 400 can also be used for immigration 408 purposes. For immigration 408 uses, the system can contain nationality information, immigration status, the legality of presence in a nationality, visa status or any other desired immigration information. The system 400 can also be used for insurance 410 information, which can include vehicle and medical insurance, as well as any other type of insurance. Another use of system 400 can include any type of identification 412 information, such as driver's license information or any other type of permit that may include identification information there on. Additionally, identification 412 can be used by a coroner 416 or medical examiner to identify a body as well as to provide contact information for next of kin. Further, the identification 412 may be used by a coroner 416, medical examiner or other party to notify any relevant agencies, such as a government social security agency, that an individual has died. System 400 can still further be used to maintain and access medical information 414, which can include medical history information, medical conditions or any other type of medical data desired. Still other uses of system 400 that pertain to housing information about any number of individuals can be visualized and may be implemented and utilized as desired.

The foregoing description and accompanying drawings illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A system for providing data, comprising:
at least one database for storing data;
a plurality of cards containing individualized information about the holders of the cards and a data storage device coupled with each of the plurality of cards, the data storage device readable by a data reading device and storing further individualized information about the holders of the cards, and the at least one database storing the individualized information from the plurality of cards; and
a plurality of authorized personnel equipped with data reading devices to read the data on the data storage device.

2. The system of claim 1, wherein the data storage device is an electronically readable medium.

3. The system of claim 1, wherein the at least one database for storing data contains information about each of the plurality of cards in a predefined jurisdiction.

4. The system of claim 1, wherein the plurality of cards are plastic.

5. The system of claim 4, wherein the data storage device is embedded into each of the plurality of cards.

6. The system of claim 4, wherein the data storage device is printed onto each of the plurality of cards.

7. The system of claim 1, wherein the individualized information is at least one of identification information and medical information.

8. The system of claim 1, wherein the plurality of cards are carried by a plurality of individuals to whom the individualized data relates.

9. The system of claim 1, wherein the data reading device is a handheld, wireless device.

10. The system of claim 1, wherein the data reading device reads the data storage device and a notification containing information about the data reading device is sent to the holder of the card.

11. A method of maintaining and disseminating data, comprising:
gathering data regarding a plurality of individuals;
storing the data in one or more centrally located databases;
storing individualized data regarding each of the plurality of individuals on a plurality of identification cards;
reading the data on the plurality of identification cards by a data reading device; and
displaying the data.

12. The method of claim 11, further comprising updating the data regarding the plurality of individuals on the centrally located database and updating the individualized data on the plurality of identification cards.

13. The method of claim 11, wherein the individualized data is stored on a machine readable medium.

14. The method of claim 11, wherein the individualized data is at least one of identification information and medical information.

15. The method of claim 11, further comprising carrying the identification cards by an individual to whom the individualized data relates to.

16. The method of claim 11, further comprising penalizing an individual for not having an identification card.

17. The method of claim 11, further comprising assessing a fee on the plurality of individuals.

18. The method of claim 11, further comprising notifying each individual upon the reading of the data on the plurality of identification cards.

19. The method of claim 11, wherein the data on the plurality of identification cards is wirelessly transmitted to a display and to a server after it is read.

20. The method of claim 11, further comprising updating the individualized data regarding each of the plurality of individuals on the plurality of identification cards.
